(19) United States
(12) Patent Application Publication
(10) Pub. No.: US 2007/0207448 A1
(43) Pub. Date: Sep. 6, 2007

(54) Method and system for using simulation techniques in ophthalmic surgery training

(75) Inventors: Bert Glaser, Baltimore, MD (US); Michael Grodin, Falls Church, VA (US)

Correspondence Address: ARENT FOX PLLC, 1050 CONNECTICUT AVENUE, N.W., SUITE 400, WASHINGTON, DC, 20036, US

(73) Assignee: The National Retina Institute

(21) Appl. No.: 11/713,669

(22) Filed: Mar. 5, 2007

Related U.S. Application Data
(60) Provisional application No. 60/778,378, filed on Mar. 3, 2006.

(51) Int. Cl. G09B 23/28

(52) U.S. Cl. 434/262

(57) ABSTRACT

A method and system for enhanced ophthalmic surgery training by using simulation techniques. Each type of ophthalmic surgery, such as retinal or cataract surgery, is broken down into a sequence of surgical tasks, and each task is programmed into the system. A user practices each task via a simulator on a virtual human subject until a pre-determined level of skill is acquired for the task. The present invention objectively and effectively assesses a user's skill and expertise level in performing ophthalmic surgery via gated performance testing, thereby ensuring that the user has a pre-determined skill and expertise level, and eliminating undue risk to patients.

### CROSS-REFERENCE TO RELATED APPLICATIONS

This application claims the benefit of U.S. Provisional Application No. 60/778,378, entitled “TASK ASSESSMENT-BASED SKILLS COMPETENCY SYSTEMS (TASC),” filed Mar. 3, 2006, the entirety of which is incorporated by reference herein.

### BACKGROUND OF THE INVENTION

1. Field of the Invention

The present invention relates to a method and system for using simulation techniques in surgery training. In particular, the present invention provides a method and system for ophthalmic surgery training using simulation via task breakdown and analysis and score-dependent gated-progression to higher-level task training.

2. Description of the Related Art

There are known in the art methods for providing ophthalmic surgery training. These known methods include observation by ophthalmic surgery trainees of experienced ophthalmic surgeons performing surgery. Eventually, after a period of observation, each trainee begins to perform ophthalmic surgery. Because the training is based primarily on observation, however, the trainees' practical experience is little or non-existent. Any practical experience a trainee may have would be gained by practicing ophthalmic surgery on animals, or other subjects that are not anatomically similar to humans, or on cadavers.

These known methods for ophthalmic surgery training are deficient in that it is not possible for trainees to break down each type of ophthalmic surgery (e.g., cataract and retinal surgery) into a sequence of separate tasks or steps, and to practice performing each task or step until they are ready to begin practicing the next surgical task or step in the sequence. Furthermore, the known methods suffer from the disadvantage of not being able to effectively assess or evaluate a trainee's skill and expertise level in performing any type of ophthalmic surgery prior to the trainee actually practicing the surgery on a living human patient. In addition, the known methods have the disadvantage of placing patients undue risk, if a trainee has not reached an acceptable level of skill prior to performing the surgery.

There is a need in the art, therefore, for methods and systems for ophthalmic surgery training by simulating the practice of ophthalmic surgery on a human patient. There is a further need in the art for methods and systems that provide enhanced ophthalmic surgery training by breaking down each type of surgery into a sequence of separate tasks or steps, and practicing each task until a pre-determined level of skill is acquired, prior to practicing the next step in the sequence. Furthermore, there is a need in the art for methods and systems for ophthalmic surgery training that have the capacity to objectively and effectively assess a trainee's skill and expertise level in performing the surgery in a low-risk environment, i.e., prior to the trainee actually practicing the surgery on a human patient, thus avoiding placing patients in situations of undue risk.

### SUMMARY OF THE INVENTION

The present invention solves the above identified needs, as well as others, by providing a method and system for ophthalmic surgery training by using simulation techniques. One embodiment of the present invention provides a method and system for enhanced ophthalmic surgery training by breaking down each type of surgery into a sequence of separate tasks or steps, and practicing each task via a simulator on a virtual human subject until a pre-determined level of skill is acquired, prior to practicing the next step in the sequence. In one embodiment, the method and system for ophthalmic surgery training of the present invention has the capacity to objectively and effectively assess a trainee's skill and expertise level in performing ophthalmic surgery via a simulator, prior to the trainee actually practicing the surgery on a human patient.

It will be readily recognized by those of ordinary skill in the art that, although the embodiments of the present invention described herein refer specifically to ophthalmic surgery, the method and system of the present invention is applicable to any type of surgery, and specifically to any surgery the performance of which may be broken down into a series of discrete tasks.

Additional advantages and novel features of the invention will be set forth in part in the description that follows, and in part will become more apparent to those skilled in the art upon examination of the following or upon learning by practice of the invention.

### BRIEF DESCRIPTION OF THE DRAWINGS

The foregoing and other objects, features, and advantages of the invention will become more readily apparent upon reference to the following detailed description of presently preferred embodiments, when taken in conjunction with the accompanying drawings in which:

FIG. 1 illustrates a flow diagram of the method of the present invention, in accordance with one embodiment;

FIG. 2 illustrates an example task breakdown of a surgical procedure, in accordance with one embodiment of the present invention;

FIG. 3 illustrates an example of gated performance testing used in conjunction with an embodiment of the present invention;

FIG. 4 illustrates exemplary system features for use in accordance with an embodiment of the present invention; and

FIG. 5 illustrates exemplary system components for use with embodiments of the present invention.

### DETAILED DESCRIPTION OF THE INVENTION

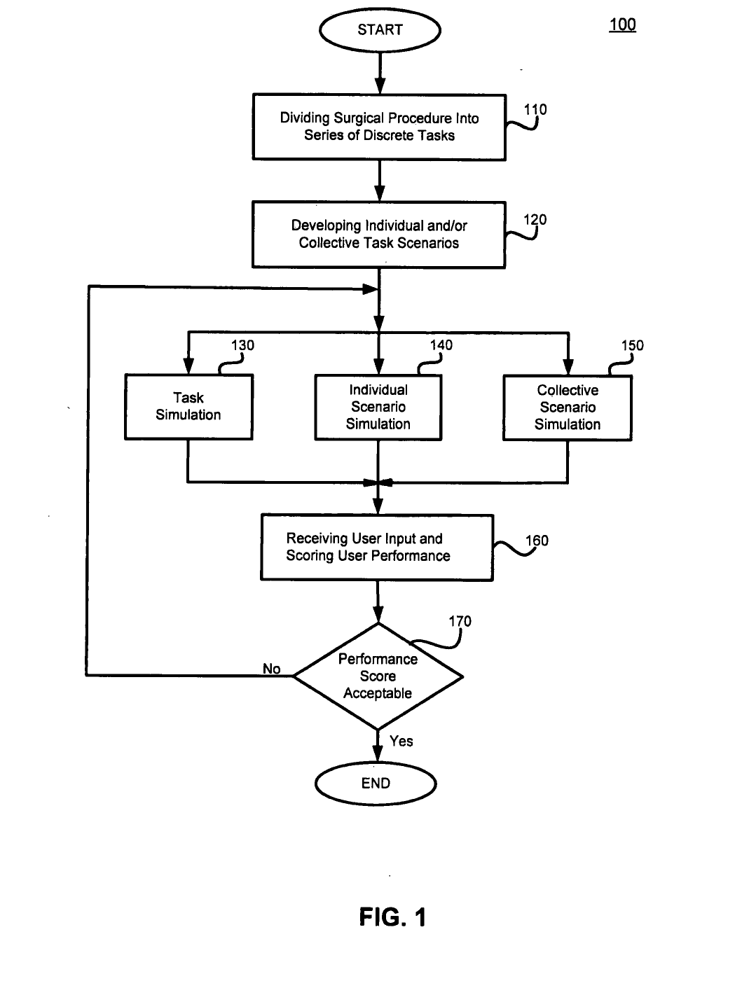

In one embodiment of the present invention, as shown in FIG. 1, a method 100 is provided for enhanced ophthalmic surgery training by simulating the practice of ophthalmic surgery on a human subject. At step 110, each surgical procedure is broken down into a series of discrete tasks to be performed as part of the procedure. The information associated with each discrete task may include: the goal of each task; the risks associated with each task; the instruments necessary to perform each task; and the task's place as part of the sequence.

At step 120, individual and/or collective task scenarios may be developed. The scenarios may include, for example, any scenario ranging from a single task to be performed by a single individual, to difficult and critical scenarios, to abnormal scenarios and scenarios involving severe complications, which may require team participation (e.g., one or more surgeons, circulation nurse(s) and/or anesthesiologist(s)). Each of these scenarios, when programmed and executed on a programmable simulator, may be performed repetitively by a user until a pre-determined level of repetitions and/or a pre-determined skill/experience level has been achieved. In accordance with one embodiment, task simulation is performed at step 130, individual scenario simulation is performed at step 140, and collective scenario simulation is performed at step 150. In one embodiment, collective scenario simulation is used to optimize and enhance surgical team performance.

Upon completion of each simulation step 130, 140 and/or 150, the received user input is assessed and scored at step 160. The scoring may be performed, for example, in accordance with agreed upon performance standards established by a panel of expert surgeons, or other objective criteria. In one embodiment, the score may reflect the extent to which the goal of each simulated task has been accomplished, or may be a combination score evaluating multiple factors, such as the user's efficiency, dexterity, decision-making and risk-avoidance capabilities, complication management, and protocol optimization. If a user's performance score is not acceptable, simulation steps 130, 140 and/or 150 are repeated until a desired performance score is achieved.

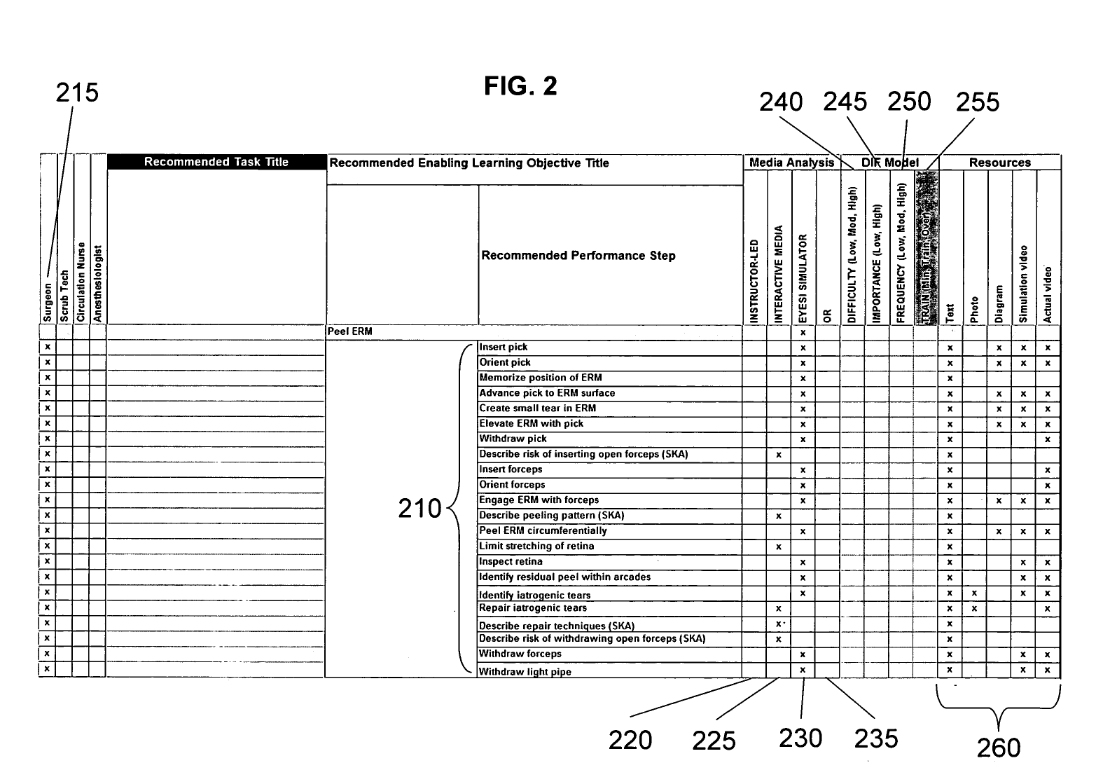

Referring now to FIG. 2, therein shown is a task breakdown of a surgical procedure, in accordance with one embodiment of the present invention. As an example, the specific surgical procedure discussed is an Epi-Retinal Membrane Peel (also referred to herein as a “Peel ERM”), which may be divided into discrete performance steps, such as steps 210 to be performed by surgeon 215, as shown in FIG. 2. In one embodiment, the discrete performance steps 210 may include: inserting a pick; orienting the pick; memorizing the position of an Epi-Retinal Membrane (ERM); advancing the pick to the ERM surface; creating a small tear in the ERM; elevating the ERM with the pick; withdrawing the pick; inserting forceps; orienting the forceps; engaging the ERM with the forceps; peeling the ERM circumferentially; inspecting the retina; identifying residual peel with arcades; identifying iatrogenic tears; and withdrawing the forceps.

In accordance with one embodiment, one or more of steps 210 may be performed in an instructor-led environment 220, may be interactive 225, performed via simulation 230, or in an operating room environment 235. Each of the steps 210 may be pre-assigned a degree of difficulty 240, importance 245 and/or frequency 250. Each user's training or skill level may be assessed 255 based on the difficulty 240, importance 245, and/or frequency 250 factors. In addition, in one embodiment, a variety of resources 260 may be used, such as instruction texts, photographs, diagrams, simulation videos, and actual videos.

Another example of an ophthalmic surgery procedure that may be performed using the method and system of the present invention is Capsulorhexis, more commonly known as cataract surgery. In one embodiment, this surgery may be divided into discrete performance steps as follows: (1) inserting a viscoelastic canula through the paracentesis incision into the anterior chamber of the eye; (2) injecting viscoelastic fluid to fill the anterior chamber; (3) removing the viscoelastic canula from the eye when viscoelastic fluid begins to egress from the incision, indicating that the anterior chamber is full; (4) inserting a cystotome through the tunnel incision oriented horizontally; (5) orienting the cystotome vertically upon entry of the anterior chamber, with the tip pointing toward the anterior lens capsule; (6) piercing the center of the lens capsule using the cystotome; (7) continuing the incision by directing the cystotome laterally 2-3 mm (depending on whether the capsulorhexis will proceed clockwise or counterclockwise); (8) completing the incision by directing it 1 mm toward the surgeon to create a triangular flap in the lens capsule; (9) inserting a capsulorhexis forceps through the tunnel incision oriented horizontally; (10) orienting the capsulorhexis vertically upon entry into the anterior chamber; (11) clasping the anterior capsular flap with the capsulorhexis at its edge; (12) directing the capsulorhexis in a circumlinear fashion staying within the plane of the anterior lens capsule; (13) while the flap proceeds circumlinearly, increasing the distance from the edge of the tear to the forceps; (14) releasing and regrasping the flap with the capsulorhexis forceps closer to the edge of the tear to maintain better control over its direction, keeping in mind that the ideal diameter of the capsulorhexis is 5-6 mm; (15) completing the capsulorhexis when the capsulorhexis tear converges at its starting point; (16) orienting the capsulorhexis forceps horizontally; and (17) removing the capsulorhexis forceps from the eye through the tunnel incision.

An alternative procedure, also divided into discrete steps, may be performed if the flap goes out to the periphery. The discrete steps in this case include the following: (1) releasing the flap from the capsulorhexis forceps; (2) orienting the capsulorhexis forceps horizontally; (3) removing the capsulorhexis forceps from the eye through the tunnel incision; (4) observing the anterior chamber and determining whether its depth is adequately; (5) if too much viscoelastic has egressed during the procedure, inserting the viscoelastic canula into the anterior chamber; (6) injecting additional viscoelastic fluid into the chamber to deepen it; and (7) removing the viscoelastic canula from the eye.

At least two options are available to complete the capsulorhexis procedure when the flap goes out to the periphery. Option I (redirecting the tear) may be divided into the following discrete steps: (1) inserting a capsulorhexis forceps through the tunnel incision oriented horizontally; (2) orienting the forceps vertically upon entry into the anterior chamber; (3) regrasping the tear close to its edge by pulling towards the center of the pupil, thereby returning the direction of the tear to its intended course; (4) releasing and regrasping the flap with the capsulorhexis forceps closer to the edge of the tear to maintain better control over its direction, keeping in mind that the ideal diameter of the capsulorhexis is 5-6 mm; (5) completing the capsulorhexis when the capsulorhexis tear converges at its starting point; (6) orienting the capsulorhexis forceps horizontally; and (7) removing the capsulorhexis forceps from the eye through the tunnel incision.

Option II for completing the capsulorhexis procedure when the flap goes out to the periphery (starting a new flap from an opposite direction) may be divided into the following discrete steps: (1) inserting the cystotome through the tunnel incision oriented horizontally; (2) orienting the cystotome vertically once the anterior chamber is entered; (3) approaching the beginning of the flap with the cystotome; (4) making an incision in the anterior lens capsule and directing it 1 mm away from the surgeon to create a new flap; (5) orienting the cystotome horizontally; (6) removing the cystotome from the eye through the tunnel incision; (7) inserting a capsulorhexis forceps through the tunnel incision oriented horizontally; (8) orienting the forceps vertically once the anterior chamber is entered; (9) grasping the new flap with the capsulorhexis forceps; (10) directing the capsulorhexis circumlinearly in the opposite direction staying within the plane of the anterior lens capsule; (11) while the flap proceeds circumlinearly, increasing the distance from the edge of the tear to the forceps; (12) releasing and regrasping the flap with the capsulorhexis forceps closer to the edge of the tear to maintain better control over its direction, keeping in mind that the ideal diameter of the capsulorhexis is 5-6 mm; (13) completing the capsulorhexis when the capsulorhexis tear converges at its starting point; (14) orienting the capsulorhexis forceps horizontally; and (15) removing the capsulorhexis forceps from the eye through the tunnel incision.

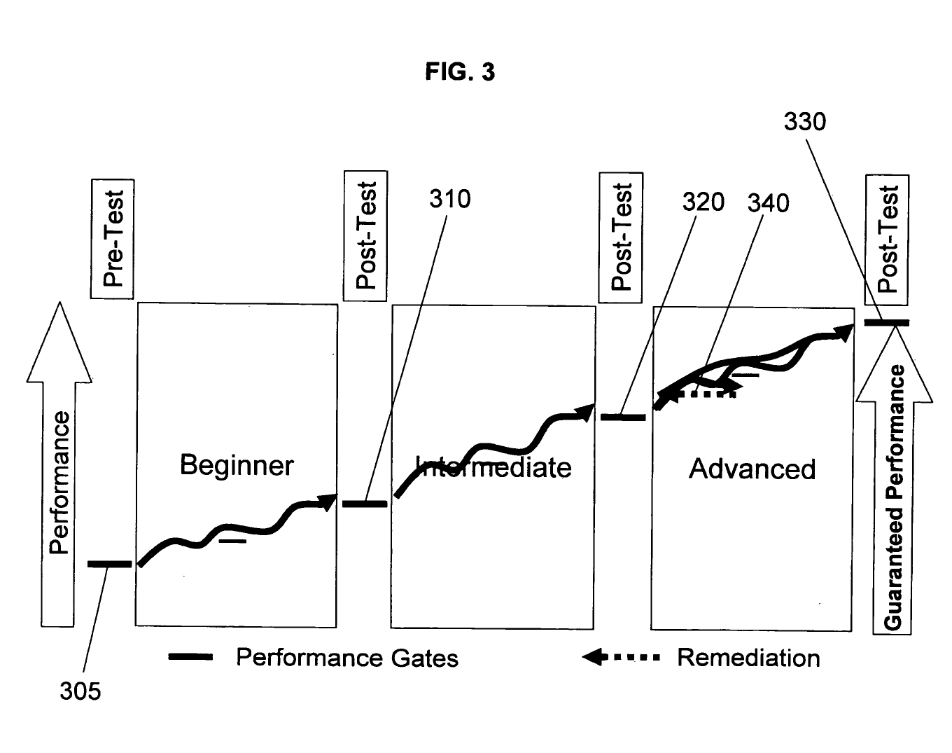

Referring now to FIG. 3, therein shown is an example of gated performance testing in accordance with an embodiment of the present invention. FIG. 3 shows three performance gates (also interchangeably referred to herein as “post-test levels”): Beginner 310; Intermediate 320; and Advanced 330. The user may have, for example, a pre-test level 305. Remediation (or multiple repetition of simulation task performance) 340 may be necessary for some users to reach the Advanced gate 330 (the third post-test level of guaranteed performance). It will be readily apparent to those of ordinary skill in the art that the present invention may be used with any other system of gated performance testing and/or testing levels.

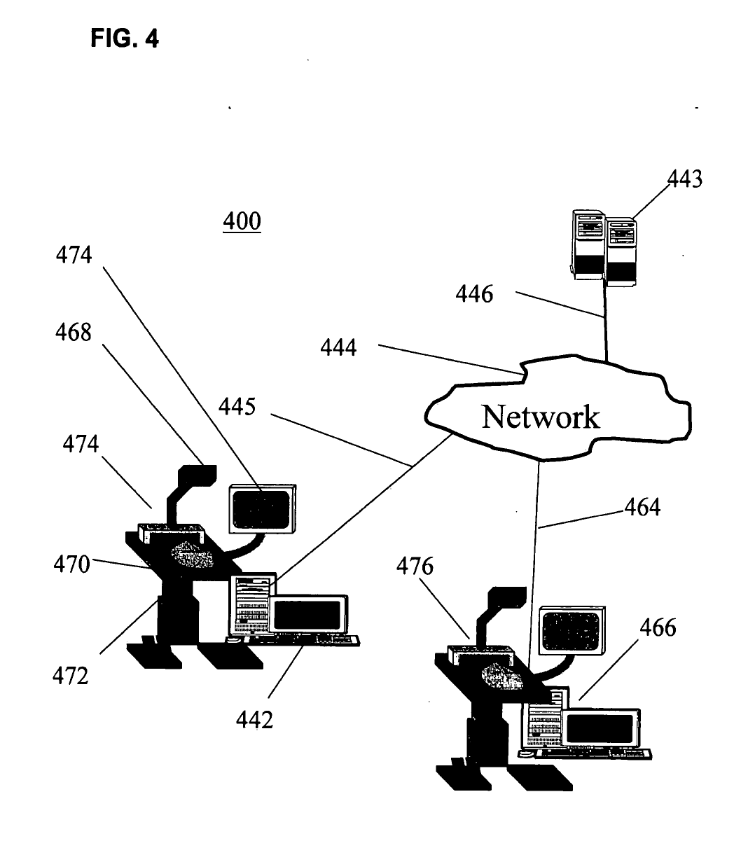

It will be appreciated that the present invention may be implemented in an Internet environment, on a stand-alone computer, in an interactive television environment, or in any other environment that supports storage and display of data. FIG. 4 presents an exemplary system diagram 400 of various hardware components and other features in accordance with an embodiment of the present invention. As shown in FIG. 4, in an embodiment of the present invention, some data for use in the system is, for example, input by a customer (also referred to interchangeably herein as a “user”) via terminals 442, 466, such as personal computers (PC), minicomputers, mainframe computers, microcomputers, telephonic devices, or wireless devices, such as hand-held wireless devices, each coupled to one or more simulators 474, 476, and a server 443, such as a PC, minicomputer, mainframe computer, microcomputer, or other device having a processor and a repository for data and/or connection to a processor and/or repository for data, via, for example, a network 444, such as the Internet or an intranet, and couplings 445, 446, 464. The couplings 445, 446, 464 include, for example, wired, wireless, or fiberoptic links. In another embodiment, the method and system of the present invention operate in a stand-alone environment, such as on a single terminal.

In operation, in an embodiment of the present invention, via the network 444, surgical procedure data, task data, individual and collective scenario data, performance standards, and/or other information is communicated with and stored on the server 443 (e.g., electronically).

In one embodiment of the present invention, simulator 474 comprises a platform 470 with a simulated human head 472 (e.g., made out of plastic or other malleable material) with a simulated human eye, which has multiple openings corresponding to various incisions via which the eye may be surgically accessed. Further, simulator 474 comprises one or more Light-Emitting Diode (LED) computer screens, which may act as a microscope 468 for the user to look through and to view the simulated virtual reality human eye, which is anatomically similar to an actual human eye. In addition, simulator 474 may have a variety of simulated instruments, such as probe 478. Probe 478 may have a sensor at one end, which, upon entry into the eye via the incisions, is recognized by the system as a specific pre-programmed surgical instrument (i.e., a pick, forceps and a light pipe, among others). Thus, when the specific instrument is recognized by the system, a user looking through microscope 468 will see the virtual reality instrument as recognized by the computer. Thus the user may perform a simulated virtual reality surgery, such as retinal, cataract, or other.

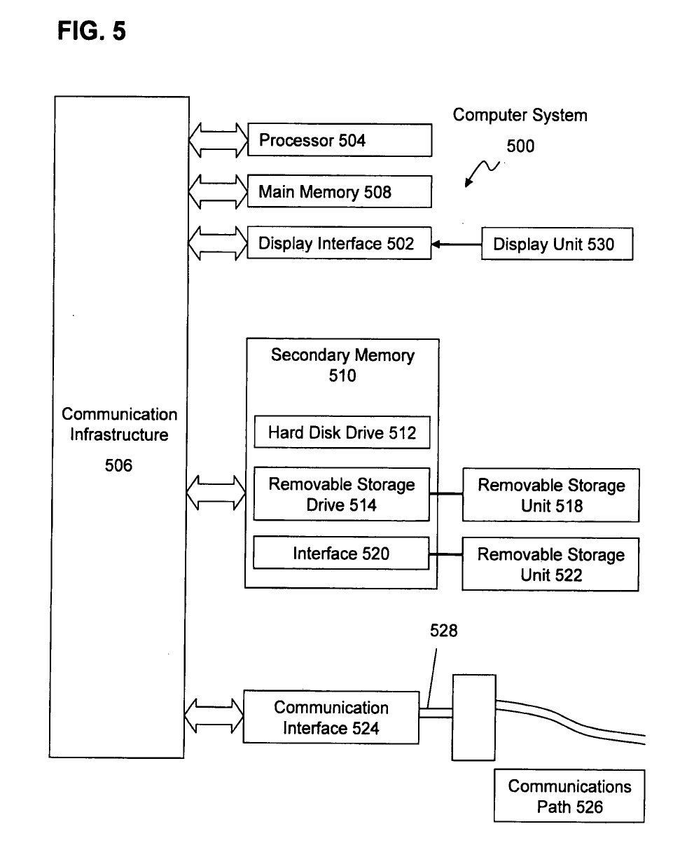

The present invention may be implemented using hardware, software or a combination thereof and may be implemented in one or more computer systems or other processing systems. In one embodiment, the invention is directed toward one or more computer systems capable of carrying out the functionality described herein. An example of such a computer system 500 is shown in FIG. 5.

Computer system 500 includes one or more processors, such as processor 504. The processor 504 is connected to a communication infrastructure 506 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 500 can include a display interface 502 that forwards graphics, text, and other data from the communication infrastructure 506 (or from a frame buffer not shown) for display on the display unit 530. Computer system 500 also includes a main memory 508, preferably random access memory (RAM), and may also include a secondary memory 510. The secondary memory 510 may include, for example, a hard disk drive 512 and/or a removable storage drive 514, representing a floppy disk drive, a magnetic tape drive, an optical disk drive, etc. The removable storage drive 514 reads from and/or writes to a removable storage unit 518 in a well-known manner. Removable storage unit 518, represents a floppy disk, magnetic tape, optical disk, etc., which is read by and written to removable storage drive 514. As will be appreciated, the removable storage unit 518 includes a computer usable storage medium having stored therein computer software and/or data.

In alternative embodiments, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow software and data to be transferred from the removable storage unit 522 to computer system 500.

Computer system 500 may also include a communications interface 524. Communications interface 524 allows software and data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals 528, which may be electronic, electromagnetic, optical or other signals capable of being received by communications interface 524. These signals 528 are provided to communications interface 524 via a communications path (e.g., channel) 526. This path 526 carries signals 528 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 514, a hard disk installed in hard disk drive 512, and signals 528. These computer program products provide software to the computer system 500. The invention is directed to such computer program products.

Computer programs (also referred to as computer control logic) are stored in main memory 508 and/or secondary memory 510. Computer programs may also be received via communications interface 524. Such computer programs, when executed, enable the computer system 500 to perform the features of the present invention, as discussed herein. In particular, the computer programs, when executed, enable the processor 504 to perform the features of the present invention. Accordingly, such computer programs represent controllers of the computer system 500.

In one embodiment where the invention is implemented using software, the software may be stored in a computer program product and loaded into computer system 500 using removable storage drive 514, hard drive 512, or communications interface 524. The control logic (software), when executed by the processor 504, causes the processor 504 to perform the functions of the invention as described herein. In another embodiment, the invention is implemented primarily in hardware using, for example, hardware components, such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

While the invention has been described in detail in particular embodiments using specific examples, it would be appreciated by those skilled in the art that various modifications of those details could be developed in light of the overall teaching of the disclosure. For example, while the invention has been described in terms of a method and system for tracking and compensation of distributors of medical test products, the invention is equally applicable to distributors, including retailers and wholesalers, of other products and services. The particular embodiments disclosed herein are intended to be illustrative only and not limiting to the scope of the invention.

What is claimed is:

1. A method for simulator-enhanced ophthalmic surgery training, the method comprising:
receiving ophthalmic surgery data comprising a sequence of discrete surgical tasks;
receiving at least one surgical task scenario;
simulating the at least one surgical task scenario;
receiving user input regarding the at least one surgical task scenario; and
scoring user performance on the at least one surgical task scenario based on the user input.

2. The method of claim 1, wherein the at least one surgical task scenario comprises at least one discrete surgical task to be performed by a user.

3. The method of claim 1, wherein the at least one surgical task scenario is selected from a group consisting of an individual scenario and a collective scenario.

4. The method of claim 1, further comprising:
evaluating user performance based on the user performance score and one or more performance gates.

5. The method of claim 4, wherein the one or more performance gates are selected from a group consisting of beginner, intermediate, and advanced.

6. The method of claim 1, further comprising:
if the user performance score is below a pre-determined level, repeating the simulating, receiving user input and scoring steps until the pre-determined performance score level is achieved by the user.

7. The method of claim 1, further comprising:
if the user performance score is above a pre-determined level, simulating another one of the at least one surgical task scenario.

8. The method of claim 1, wherein the ophthalmic surgery is selected from a group consisting of cataract surgery and retinal surgery.

9. The method of claim 1, wherein the at least one surgical task scenario further comprises:
inserting a pick;
orienting the pick;
memorizing a position of an Epi-Retinal Membrane (ERM);
advancing the pick to the ERM surface;
creating a small tear in the ERM;
elevating the ERM with the pick;
withdrawing the pick;
inserting forceps;
orienting the forceps;
engaging the ERM with the forceps;
peeling the ERM circumferentially;
inspecting retina;
identifying residual peel with arcades;
identifying iatrogenic tears; and
withdrawing the forceps.

10. A method for simulator-enhanced Epi-Retinal Membrane Peel (Peel ERM) surgery training, the method comprising:
receiving Peel ERM data comprising a sequence of discrete surgical tasks;
receiving at least one surgical task scenario;
simulating the at least one surgical task scenario;
receiving user input regarding the at least one surgical task scenario; and
scoring user performance on the at least one surgical task scenario based on the user input;
wherein the at least one surgical task scenario further comprises:
inserting a pick;
orienting the pick;
memorizing a position of an Epi-Retinal Membrane (ERM);
advancing the pick to the ERM surface;
creating a small tear in the ERM;
elevating the ERM with the pick;
withdrawing the pick;
inserting forceps;
orienting the forceps;
engaging the ERM with the forceps;
peeling the ERM circumferentially;
inspecting retina;
identifying residual peel with arcades;
identifying iatrogenic tears; and
withdrawing the forceps.

11. A system for simulator-enhanced ophthalmic surgery training, the system comprising:
receiving means for receiving ophthalmic surgery data comprising a sequence of discrete surgical tasks;
receiving means for receiving at least one surgical task scenario;
simulating means for simulating the at least one surgical task scenario;
receiving means for receiving user input regarding the at least one surgical task scenario; and
scoring means for scoring user performance on the at least one surgical task scenario based on the user input.

12. The system of claim 11, wherein the at least one surgical task scenario comprises at least one discrete surgical task to be performed by a user.

13. The system of claim 11, wherein the at least one surgical task scenario is selected from a group consisting of an individual scenario and a collective scenario.

14. The system of claim 11, further comprising:
evaluating means for evaluating user performance based on the user performance score and one or more performance gates.

15. The system of claim 11, wherein the ophthalmic surgery is selected from a group consisting of cataract surgery and retinal surgery.

16. The system of claim 11, wherein the at least one surgical task scenario further comprises:
inserting a pick;
orienting the pick;
memorizing a position of an Epi-Retinal Membrane (ERM);
advancing the pick to the ERM surface;
creating a small tear in the ERM;
elevating the ERM with the pick;
withdrawing the pick;
inserting forceps;
orienting the forceps;
engaging the ERM with the forceps;
peeling the ERM circumferentially;
inspecting retina;
identifying residual peel with arcades;
identifying iatrogenic tears; and
withdrawing the forceps.

17. A system for simulator-enhanced Epi-Retinal Membrane Peel (Peel ERM) surgery training, the system comprising:
receiving means for receiving Peel ERM data comprising a sequence of discrete surgical tasks;
receiving means for receiving at least one surgical task scenario;
simulating means for simulating the at least one surgical task scenario;
receiving means for receiving user input regarding the at least one surgical task scenario; and
scoring means for scoring user performance on the at least one surgical task scenario based on the user input;
wherein the at least one surgical task scenario comprises:
inserting a pick;
orienting the pick;
memorizing a position of an Epi-Retinal Membrane (ERM);
advancing the pick to the ERM surface;
creating a small tear in the ERM;
elevating the ERM with the pick;
withdrawing the pick;
inserting forceps;
orienting the forceps;
engaging the ERM with the forceps;
peeling the ERM circumferentially;
inspecting retina;
identifying residual peel with arcades;
identifying iatrogenic tears; and
withdrawing the forceps.

18. A computer program product comprising a computer usable medium having control logic stored therein for causing a computer to perform simulator-enhanced ophthalmic surgery training, the control logic comprising:
first computer readable program code means for receiving ophthalmic surgery data comprising a sequence of discrete surgical tasks;
second computer readable program code means for receiving at least one surgical task scenario;
third computer readable program code means for simulating the at least one surgical task scenario;
fourth computer readable program code means for receiving user input regarding the at least one surgical task scenario; and
fifth computer readable program code means for scoring user performance on the at least one surgical task scenario based on the user input.

19. A computer program product comprising a computer usable medium having control logic stored therein for causing a computer to perform simulator-enhanced Epi-Retinal Membrane Peel (Peel ERM) surgery training, the control logic comprising:
first computer readable program code means for receiving Peel ERM data comprising a sequence of discrete surgical tasks;
second computer readable program code means for receiving at least one surgical task scenario;
third computer readable program code means for simulating the at least one surgical task scenario;
fourth computer readable program code means for receiving user input regarding the at least one surgical task scenario; and
fifth computer readable program code means for scoring user performance on the at least one surgical task scenario based on the user input;
wherein the at least one surgical task scenario comprises:
inserting a pick;
orienting the pick;
memorizing a position of an Epi-Retinal Membrane (ERM);
advancing the pick to the ERM surface;
creating a small tear in the ERM;
elevating the ERM with the pick;
withdrawing the pick;
inserting forceps;
orienting the forceps;
engaging the ERM with the forceps;
peeling the ERM circumferentially;
inspecting retina;
identifying residual peel with arcades;
identifying iatrogenic tears; and
withdrawing the forceps.
